(19) United States
(12) Patent Application Publication
(10) Pub. No.: US 2024/0250539 A1
(43) Pub. Date: Jul. 25, 2024

(54) BATTERY MANAGEMENT SYSTEM FOR A BATTERY STORAGE DEVICE, ASSEMBLY, AND METHOD

(71) Applicant: HELLA GmbH & Co. KGaA, Lippstadt (DE)

(72) Inventors: Frank VALENTIN, Warendorf (DE); Ahmet OEZTUERK, Lippstadt (DE)

(73) Assignee: HELLA GmbH & Co. KGaA, Lippstadt (DE)

(21) Appl. No.: 18/623,368

(22) Filed: Apr. 1, 2024

Related U.S. Application Data
(63) Continuation of application No. PCT/EP2022/076395, filed on Sep. 22, 2022.

(30) Foreign Application Priority Data
Oct. 1, 2021 (DE) 10 2021 125 556.2

(51) Int. Cl. H02J 7/00; B60L 3/04; H01M 10/42

(52) U.S. Cl. CPC H02J 7/0034; B60L 3/04; H01M 10/425; H02J 7/0068; H01M 2010/4271

(57) ABSTRACT

A battery management system for a battery storage device and for connecting the battery storage device to a DC voltage source, preferably a battery charging device or a circuit in a vehicle, having at least one semiconductor component as well as at least one diode. The current is conducted to a connection of the battery storage device to the DC voltage source with an incorrect pole via the respective semiconductor element. A detection circuit may be used to detect the incorrect pole and actuate the semiconductor elements. In this manner, the diodes are advantageously prevented from being damaged.

This nonprovisional application is a continuation of International Application No. PCT/EP2022/076395, which was filed on Sep. 22, 2022, and which claims priority to German Patent Application No. 10 2021 125 556.2, which was filed in Germany on Oct. 1, 2021, and which are both herein incorporated by reference.

### BACKGROUND OF THE INVENTION

### Field of the Invention

The invention relates to a battery management system for a battery storage device and for connecting the battery storage device to a DC voltage source, preferably to a battery charging device or a circuit in a vehicle, having at least one input for connecting to the battery charging device or for connecting to the circuit in the vehicle, with a first terminal for a positive potential and a second terminal for a negative potential of the battery charging device or of the circuit, and at least one output having a first terminal and a second terminal, the first terminal being at least indirectly connectable to an anode of the battery storage device, and the second terminal being at least indirectly connectable to a cathode of the battery storage device, and including at least one battery disconnect switch, wherein a first terminal of the battery disconnect switch is connected to the first terminal of the input, and a second terminal of the battery disconnect switch is connected to the first terminal of the output. The invention further relates to an assembly and to a method for operating the battery management system.

### Description of the Background Art

Energy efficiency and electrification are becoming increasingly important in all sectors of the economy. In particular in the automotive industry, advancements have intensified in these areas. Due to ever-stringent environmental requirements, in particular reduced CO2 emissions, electromobility is gaining more and more importance.

In addition to the strictly electrically driven vehicles, the importance of hybrid drives or mild hybrid drives is increasing. The special feature of mild hybrid vehicles is that they cannot be driven fully electrically. The internal combustion engine is merely assisted by an electric motor. The system is automatically charged by the braking system during coasting and braking.

Due to the ever-increasing number of electrical consumers within a vehicle, systems are gaining more acceptance which are not operated solely at the customary 12 V vehicle electrical system voltage, but which also have an electrical supply system with a higher voltage level that is typically below the 60 V direct voltage limit for high-voltage systems. It is thus possible to transfer several times the power with the same conductor cross sections.

Battery storage devices are subject to aging phenomena, and must be serviced and/or replaced. For this purpose it is customary to remove the battery storage device from the vehicle and charge it on an external battery charging device, for example. After the maintenance and/or charging operation, the battery storage device is once again installed in the vehicle. These work steps are a source of potential error. In particular, it is conceivable that for a connection of the battery storage device to the external battery charging device, terminals of the battery charging device may not be connected to the terminals of the input of the battery management system intended for this purpose, and instead are interchanged. This case is referred to as a reversed-polarity state. This is also conceivable for any type of connection of a terminal of a circuit to the input of the battery management system.

If no protective measures are taken, a reversed-polarity state results in failure of the battery management system, in which the battery disconnect switch is typically damaged or destroyed. This damage or destruction results in failure of the battery management system, among other things. Failure of the battery management system is undesirable and should be avoided.

### SUMMARY OF THE INVENTION

It is therefore an object of the present invention to improve a battery management system, and in particular to prevent a defect in components in the event of reversed polarity.

The object is achieved in an example by a battery management system for a battery storage device and for connecting the battery storage device to a DC voltage source, preferably to a battery charging device or a circuit in a vehicle, wherein the battery management system comprises: at least one input for connecting to the battery charging device or for connecting to the circuit in the vehicle, having a first terminal for a positive potential and a second terminal for a negative potential of the battery charging device or of the circuit; at least one output having a first terminal and a second terminal, wherein the first terminal is at least indirectly connectable to an anode of the battery storage device, and the second terminal is at least indirectly connectable to a cathode of the battery storage device; and at least one battery disconnect switch, wherein a first terminal of the battery disconnect switch is connected to the first terminal of the input, and a second terminal of the battery disconnect switch is connected to the first terminal of the output, wherein at least one semiconductor component is connected to the first terminal and to the second terminal of the input, wherein the at least one semiconductor component has a first branch and a second branch, the first and second branches being situated in parallel between the first terminal and the second terminal of the semiconductor component, wherein the first branch includes at least one diode, the anode of the diode being connected to the second terminal of the input, and the cathode being connected to the first terminal of the input, at least indirectly, wherein the diode blocks in a first state when a positive potential is present at the first terminal of the input and a negative potential is present at the second terminal of the input, and the diode conducts in a second state when a negative potential is present at the first terminal of the input and a positive potential is present at the second terminal of the input, i.e., a reversed-polarity state, wherein the second branch includes at least one controllable switching element, wherein in a switched-on state of the controllable switching element an ohmic resistance of the second branch is significantly lower than that of the first branch, for the reversed-polarity state, a current flow through the at least one battery disconnect switch is preventable.

Due to the expansion of the battery management system with the semiconductor component, in the reversed-polarity state, the current flow is initially conducted through the diode situated in the first branch of the semiconductor component, the so-called body diode. It is advantageous that the diode is operated in the conducting direction when a reversed-polarity state occurs. It is thus possible for the current flow to be automatically conducted through the first branch of the semiconductor component without having to initially detect the error at some other location. However, the current flow through the diode results in a significant power loss, which in turn results in heating of the diode. Diodes, or semiconductor components having such a diode, which are designed for such power losses are costly and should therefore be avoided. For this purpose, the semiconductor component has a second branch with a controllable switching element. If the controllable switching element is activated to close, the current flow is taken over by the second branch. The second branch has a significantly lower ohmic resistance than the first branch, as a result of which the power loss and thus the heating of the semiconductor component are reduced.

In the case of a correct connection, for example of the external battery charging device, the battery management system is not adversely affected by the semiconductor component, since the diode, which is situated in the first branch of the semiconductor component, blocks.

There is an option for the battery management system to include a detection circuit, the reversed-polarity state being recognizable via the detection circuit.

It may be provided that after a reversed-polarity state is detected, the detection circuit transfers a signal to a controller and/or regulator, whereupon the controller and/or regulator activates the controllable switching element to close.

There is an option for the controller and/or regulator to be a microcontroller.

It may particularly advantageously be provided that the detection circuit accepts no quiescent current; i.e., the battery storage device supplies the controller and/or regulator with power only in the case of a reversed-polarity state. This is particularly important in order for the battery storage device to not be subjected to load when the vehicle is switched off, for example, and the battery storage device is not charged by recuperation during travel. Discharging of the battery storage device through the detection circuit is avoided.

There is an option for the battery storage device to be a low-voltage battery storage device. Such a low-voltage energy store may have a voltage of 12 V, 24 V, of the or 48 V. In addition to the known 24 V battery storage devices in vehicles, 48 V battery storage devices are becoming increasingly common, and in mild hybrid vehicles allow greater power of the battery storage device.

It may be provided that the semiconductor component is a MOSFET, in particular a power MOSFET. It is likewise conceivable to use other semiconductor components that are characterized by two parallel branches, wherein one branch is directly conductive and one branch may be switched on. Via a combination of components, it is also conceivable to achieve two parallel branches having the desired features.

The at least one battery disconnect switch can be a MOSFET, in particular a power MOSFET. By use of the battery disconnect switch, the separation between the battery storage device and the vehicle electrical system is achieved if necessary, for example in the case of an error.

An assembly advantageously includes at least one battery management system according to the invention, a battery storage device, and a DC voltage source.

The method for operating a battery management system according to the invention provides that in the reversed-polarity state, in which a negative potential is present at the first terminal of the input and a positive potential is present at the second terminal of the input, the diode of the at least one semiconductor component conducts a current from the second terminal of the input to the first terminal of the input through the first branch of the at least one semiconductor component, thus preventing current flow through the at least one battery disconnect switch.

It may also be provided that the detection circuit detects the reversed-polarity state, and after the detection, transfers a signal to the controller and/or regulator, whereupon the controller and/or regulator activates the controllable switching element to close.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE shows a block diagram of an assembly according to the invention together with a DC voltage source.

### DETAILED DESCRIPTION

The assembly according to the invention illustrated in the FIGURE includes a battery management system 1 for a battery storage device 10, a battery storage device 10, and a DC voltage source 2, which in the present case is a battery charging device 2.

The battery management system 1 includes an input having a first terminal 3 and a second terminal 4, an output having a first terminal 5 and a second terminal 6, two battery disconnect switches 7a, 7b, two semiconductor components 8a, 8b, and a detection circuit 9. The first terminal 3 of the input is at least indirectly connected to the first terminal 5 of the output, and the second terminal 4 of the input is at least indirectly connected to the second terminal 6 of the output.

The first terminal 5 of the output is connected to an anode of the battery storage device 10, and the second terminal 6 of the output is connected to a cathode of the battery storage device 10. A first terminal of the battery charging device 2 is connected to the first terminal 3 of the input, and a second terminal of the battery charging device 2 is connected to the second terminal 4 of the input.

The FIGURE shows, as battery disconnect switches 7a, 7b, two normally blocking n-channel power MOSFETs situated in series between the first terminal 3 of the input and the first terminal 5 of the output. The drain terminal of the first battery disconnect switch 7a is connected to the first terminal 3 of the input. The drain terminal of the second battery disconnect switch 7b is connected to the first terminal 5 of the output. The source terminals of the two battery disconnect switches 7a, 7b are connected to one another.

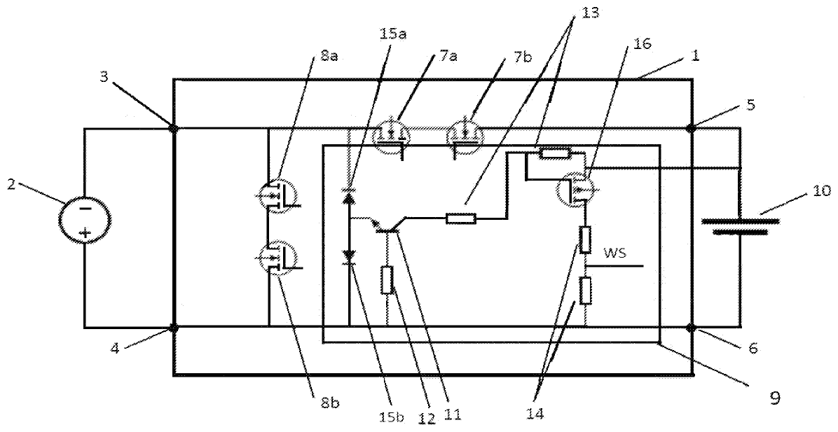

Two semiconductor components 8a, 8b that are connected in series are provided in the battery management system 1. MOSFETS are used as semiconductor components 8a, 8b in FIG. 1. The first terminal 3 of the input is connected to the drain terminal of the first semiconductor component 8a. The second terminal 4 of the input is connected to the source terminal of the second semiconductor component 8b. The source terminal of the first semiconductor component 8a is connected to the drain terminal of the second semiconductor component 8b.

The detection circuit 9 includes a transistor 11, preferably a bipolar transistor 11, a resistor 12, two diodes 15a, 15b, two voltage dividers 13, 14, and a MOSFET 16.

Two diodes 15a, 15b that are connected in series are provided in the detection circuit 9. The first terminal 3 of the input is connected to the cathode of the first diode 15a. The second terminal 4 of the input is connected to the cathode of the second diode 15b. The anodes of the two diodes 15a, 15b are connected to one another.

The emitter of the transistor 11 is connected to the anodes of the two diodes 15a, 15b. The collector of the transistor 11 is connected to a first terminal of the first voltage divider 13. The base of the transistor 11 is indirectly connected to the second terminal 4 of the input via the resistor 12. A second terminal of the first voltage divider 13 is connected to the first terminal 5 of the output. When the detection circuit is activated, a “wake-up signal” WS is provided. By use of the wake-up signal WS, a control, in particular the battery management system 1, may be activated/wakened.

The drain terminal of the MOSFET 16 is connected to a first terminal of the second voltage divider 14. The source terminal of the MOSFET 16 is connected to the first terminal 5 of the output. The gate terminal of the MOSFET 16 is connected to a node between resistors of the first voltage divider 13. A second terminal of the second voltage divider 14 is connected to the second terminal 6 of the output.

In the FIGURE it is apparent that a negative potential of the battery charging device 2 is present at the first terminal 3 of the input, and a positive potential of the battery charging device 2 is present at the second terminal 4 of the input. This may be the case, for example, when during service, the battery storage device 10 including the battery management system 1 is connected to a battery charging device 2, and the intended arrangement of the terminals is overlooked. This is generally known as a reversed-polarity state. This reversed-polarity state may also be brought about in some other way whenever the battery storage device 10 including the battery management system 1 is reconnected to the input of the battery management system 1.

In the reversed-polarity state, a current of the battery charging device 2 flows through the two semiconductor components 8a, 8b. The current is limited by the battery charging device 2. 100 A is a typical magnitude of the current. Since the current flow through the two semiconductor components 8a, 8b occurs only in the reversed-polarity state, it is sufficient to dimension the semiconductor components 8a, 8b in such a way that they may receive the current of the battery charging device 2 without damage.

The current through the first branch of the semiconductor components 8a, 8b initially flows through a diode that conducts in the current flow direction, the so-called body diode or substrate diode. The relatively high forward voltage of the diode results in increased power loss. This power loss in turn results in increased temperature of the semiconductor component. After a period of a few seconds, which may be 2 to 10 seconds, depending on the semiconductor component, the semiconductor components 8a, 8b may possibly be damaged.

In addition to the current through the first branch of the semiconductor components 8a, 8b, a low current flows through the resistor 12, the transistor 11, and one of the two diodes 15a.

As the result of a low control current, for example 10 μA, at the transistor 11, the transistor is switched into a conducting state. The conducting state of the transistor 11 allows a current flow through the first voltage divider 13, which in turn transfers the MOSFET 16 into a conducting state. A current flow through the second voltage divider 14 is then possible. A voltage drops across the second voltage divider 14, which prompts a controller and/or regulator to activate the controllable switching elements of the semiconductor components 8a, 8b to close. The controller and/or regulator is connected to a node between resistors of the second voltage divider 14.

After the controllable switching elements close, the second branch of the semiconductor components 8a, 8b is conductive. The current flowing from the connected battery charging device 2 through the circuit is then conducted across the second branch.

The second branch has a resistance that is significantly lower than the resistance of the first branch. The power loss within the semiconductor components 8a, 8b may be greatly reduced in this way. The temperature increase in the semiconductor components 8a, 8b is reduced or is reversed, and the semiconductor components 8a, 8b are cooled.

Due to the small temperature increase, it is possible for the semiconductor components 8a, 8b to be acted on by the current from the battery charging device 2 for an extended period, preferably 60 s.

In the design of the battery management system 1 according to the invention, current flow through the battery disconnect switches 7a, 7b, and thus damage to the battery disconnect switches 7a, 7b, is prevented. After the reversed-polarity state is identified and eliminated, the battery management system 1 may be further operated without damage.

For the case that the battery charging device 2 is connected to the input of the battery management system 1 in such a way that a positive potential is present at the first terminal 3 of the input and a negative potential is present at the second terminal 4 of the input, the diode blocks in the first branch of the semiconductor components 8a, 8b, and the current flows across the battery disconnect switches 7a, 7b and into the battery storage device 10, provided that the controllable switching elements are switched on.

In summary, the invention relates to a battery management system 1 for a battery storage device 10 and for connecting the battery storage device 10 to a DC voltage source 2, preferably to a battery charging device 2 or to a circuit in a vehicle 2, having at least one semiconductor component 8a, 8b and at least one diode 15a, 15b, wherein the current is conducted across the respective semiconductor component 8a, 8b to a connection of the battery storage device 10 to the DC voltage source 2 with an incorrect polarity. Optionally, a detection circuit 9 is used to detect the incorrect (reversed) polarity and activate the semiconductor components 8a, 8b. The diodes (15a, 15b may advantageously be protected in this way.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery management system for a battery storage device and for connecting the battery storage device to a DC voltage source or a battery charging device or a circuit (2) in a vehicle, the battery management system comprising:
at least one input to connect to the battery charging device or to connect to the circuit in the vehicle, the at least one input having a first terminal for a positive potential and a second terminal for a negative potential of the battery charging device or of the circuit;
at least one output having a first terminal and a second terminal, the first terminal being at least indirectly connectable to an anode of the battery storage device, and the second terminal being at least indirectly connectable to a cathode of the battery storage device;
at least one battery disconnect switch, a first terminal of the battery disconnect switch being is connected to the first terminal of the input, and a second terminal of the battery disconnect switch being connected to the first terminal of the at least one output,
at least one semiconductor component connected to the first terminal of the at least one input and to the second terminal of the at least one input, the at least one semiconductor component having a first branch and a second branch, the first and second branches being arranged in parallel between the first terminal and the second terminal of the semiconductor component, the first branch having at least one diode, an anode of the diode being connected to the second terminal of the at least one input, and a cathode being connected to the first terminal of the input, at least indirectly,
wherein the at least one diode blocks in a first state when a positive potential is present at the first terminal of the input and a negative potential is present at the second terminal of the input, and the diode conducts in a second state when a negative potential is present at the first terminal of the input and a positive potential is present at the second terminal of the input,
wherein the second branch includes at least one controllable switching element,
wherein in a switched-on state of the controllable switching element an ohmic resistance of the second branch is lower than that of the first branch by a factor of two, or by a factor of 10, and
wherein in a reversed-polarity state, a current flow through the at least one battery disconnect switch is preventable.

2. The battery management system for a battery storage device according to claim 1, wherein the battery management system includes a detection circuit, the reversed-polarity state being recognizable via the detection circuit.

3. The battery management system for a battery storage device according to claim 1, wherein after a reversed-polarity state is detected, the detection circuit provides a signal to a controller and/or regulator, and wherein the controller and/or regulator are provided for to close the controllable switching element.

4. The battery management system for a battery storage device according to claim 3, wherein the controller and/or regulator is a microcontroller.

5. The battery management system for a battery storage device according to claim 3, wherein the detection circuit accepts no quiescent current and wherein the battery storage device supplies the controller and/or regulator with power only in the case of a reversed-polarity state.

6. The battery management system for a battery storage device according to claim 1, wherein the battery storage device is a low-voltage battery storage device having a nominal voltage of 12 to 60 volts.

7. The battery management system for a battery storage device according to claim 1, wherein the semiconductor component is a MOSFET or a power MOSFET.

8. The battery management system for a battery storage device according to claim 1, wherein the at least one battery disconnect switch is a MOSFET or a power MOSFET.

9. An assembly comprising:
the battery management system according to claim 1;
a battery storage device; and
a DC voltage source.

10. A method for operating a battery management system according to claim 1, the method comprising:
determining a reversed-polarity state, in which a negative potential is present at the first terminal of the input and a positive potential is present at the second terminal of the input; and
conducting, via the diode of the at least one semiconductor component a current from the second terminal of the input to the first terminal of the input through the first branch of the at least one semiconductor component to prevent current flow through the at least one battery disconnect switch.

11. The method according to claim 10, wherein the detection circuit detects the reversed-polarity state, and after the detection, transfers a signal to a controller and/or regulator, and wherein the controller and/or regulator activates the controllable switching element to close.
